(19) United States
(12) Patent Application Publication
(10) Pub. No.: US 2014/0215789 A1
(43) Pub. Date: Aug. 7, 2014

(54) Rotational Locking and Attachment Mechanism

(71) Applicant: Mark H. Becker, Vista, CA (US)

(72) Inventor: Mark H. Becker, Vista, CA (US)

(21) Appl. No.: 14/167,500

(22) Filed: Jan. 29, 2014

Related U.S. Application Data
(60) Provisional application No. 61/761,553, filed on Feb. 6, 2013.

(51) Int. Cl. F16B 17/00

(52) U.S. Cl. CPC F16B 17/00
USPC 29/426.4; 403/376; 29/525.02

(57) ABSTRACT

This invention is an assembling device for attaching two objects together. It comprises a male extension firmly attached to the first object and a female extension firmly attached to the second object. The female extension is configured to fit over the male extension and is equipped with arcuate segments carrying on its outer surface pressure pads and relief pockets. The invention also comprises a locking ring configured to fit over the female extension and carrying on its inner surface pressure pads and relief pockets. The device is locked by rotating the locking rings such that the pressure pads on its inner surface match in position the pressure pads on the arcuate segments. The device is unlocked by rotating the device such that the pressure pads face the relief pockets. Rotatory movement is limited by pins or dowels mounted on the locking ring and by stopping cavities on the female extension.

### FIELD OF THE INVENTION

This invention claims the benefit of U.S. Provisional Application No. 61761553 titled, “Mechanical Locking Collar that is Rotary Actuated,” filed on Feb. 6, 2013 and which is hereby incorporated by reference. Applicant claims priority pursuant to 35 U.S.C. Par 119(e)(i). The present invention relates to the mechanical assembly of objects.

### BACKGROUND

Attaching objects to one another is a recurring problem in many fields ranging from consumer products, medical, industrial and military. Products needing ease of such assembly include but are not limited to cameras, optical magnifying devices, optical projectors, infrared and ultra-violet vision devices, smart phones, audio projectors, microphones, satellites, automotive products and power transmission devices such as gears, pulleys, sprockets, belts, chains, motors, engines, generators, brakes, clutches, and pumps.

There is a need for improvement of such assembling technology.

Further features, aspects, and advantages of the present invention over the prior art will be more fully understood when considered with respect to the following detailed description and claims.

### SUMMARY OF THE INVENTION

This invention is an assembling device for attaching a first object to a second object comprising:
a. A male extension attached to a first object. The attachment mechanism may be permanent or may allow the removal of the male extension from the first object.
b. A female extension permanently or removably attached to a second object.

The female extension is configured to fit over the male extension and is equipped with arcuate segments. The arcuate segments carry on their outer surface a set of pressure pads and a set of relief pockets.
c. A locking ring configured to fit over the female extension. The locking ring is equipped on its inner surface with a second set of pressure pads and a second set of relief pockets.
d. In the preferred embodiment pins or dowels are inserted into the locking ring and are long enough to penetrate stopping cavities configured in the female extension. In combination, the locking pins or dowels with the stopping cavities limit the rotational movement of the locking ring with respect the female extension to prevent overtightening. Typically, the locking ring is mounted permanently on the female extension. However, this does not preclude the possibility that the locking ring be removably mounted on the female extension. The locked assembly comprising the locking ring and female extension can rotate clockwise or counter-clockwise to lock or unlock the assembly onto the male extension.

The locking ring is configured to be in the unlocked state when the pressure pads on its inner surface are juxtaposed with the pressure pads on the arcuate segments, and the relief pockets on its inner surface are juxtaposed with the relief pockets in the arcuate segments. The locking ring is configured to be in the locked state when the pressure pads on its inner surface are juxtaposed with the pressure pads on the arcuate segments and the relief pockets on its inner surface are juxtaposed with the relief pockets on the arcuate segments.

Variations of the above preferred embodiment include configuring the male extension as an axle with a polygonal or cylindrical cross-section. Other variations include configuring the first object, the second object or the locking ring such that at least one of these can be grabbed and rotated by a wrench. Typically, a wrench could be used to grab the first object and a second wrench to grab the second object.

This invention is a locking collar mechanism design to rigidly fasten a cylindrical object to another cylindrical, hexagonal, pentagonal, square, triangular or non-cylindrical object. The surfaces of at least the locking ring, the female extension or the male extension are knurled or textured or polygonal, or carry a handle, thereby facilitating handling. The locking process may or may not require any tools such as wrenches and the actuation takes place in less than 180 degrees of rotation. There are no threads that may strip if over-tightened as is the case with threaded locking collars featuring conical friction locking surfaces.

To prevent overtightening, rotational movement is limited by pins or dowels inserted through the locking ring and penetrating stopping cavities configured in the female extension. The device can be configured to actuate in angles less than 180 degrees such as but not limited to 120 degrees, 90 degrees, 60 degrees, 45 degrees, 30 degrees, 15 degrees and others. The rotation of the locking ring aligns the ring pressure pads and the collet pressure pads. When the pads are aligned, the radial pressure causes the inside diameter of the device to collapse forming a smaller inside diameter. When the device is placed over a cylindrical object and the locking ring is actuated, the collapse of the inside diameter causes a friction fit between the device and the cylindrical object. This friction fit causes the device to become mechanically locked together with the cylindrical object, preventing relative motion between the device and the cylindrical object.

This invention can be used in the quick assembly of structures, as a multiple socket joint which locks to multiple structural members; such as triangles, squares, cubes, dodecahedrons and other geometric shapes. It can be used in telescoping tubular poles and structures. It can be used in power transmission devices such as motors, gears, pulleys, shafts, sprockets, dials, brakes, clutches, damping devices, etc. It can be used to join sensing devices such as encoders, resolvers, tachometers, speedometers, odometers, to rotating or non-rotating digital or analog devices. It can be configured to attach and lock cylindrical, square, hexagonal, octagonal objects or other such shaped objects to each other.

### BRIEF DESCRIPTION OF THE DRAWINGS

FIG. 1 illustrates the preferred embodiment of this invention showing the male segment, the female segment equipped with arcuate segments and the locking ring.

FIG. 2 shows a possible variation wherein the male extension has a cross-section in the shape of a polygon.

FIG. 3 is a cross-sectional view of the locking ring in the lock position, showing the pressure pads on the locking ring in contact with the pressure pads on the female extension.

FIG. 4 is a cross-sectional view of the locking ring in the unlock position, showing the pressure pads on the locking ring occupying the relief pockets in the female extension.

FIG. 5 show a locking ring assembled with a female extension and maximally rotated clockwise.

FIG. 5A shows the position of a locking pin in a female extension and maximally rotated clockwise.

FIG. 5B show a locking ring assembled with a female extension and maximally rotated counterclockwise.

FIG. 5C shows the position of a locking pin in a female extension and maximally rotated counterclockwise.

FIG. 6 shows a possible variation wherein the male extension is cylindrical in cross-section.

FIG. 7 shows a possible variation wherein the object attached to the female extension is configured to be grabbed and rotated by at least one wrench.

FIG. 8 illustrates a male extension equipped on its external surface with a series of bosses, protuberances, teeth or facets.

### DETAILED DESCRIPTION

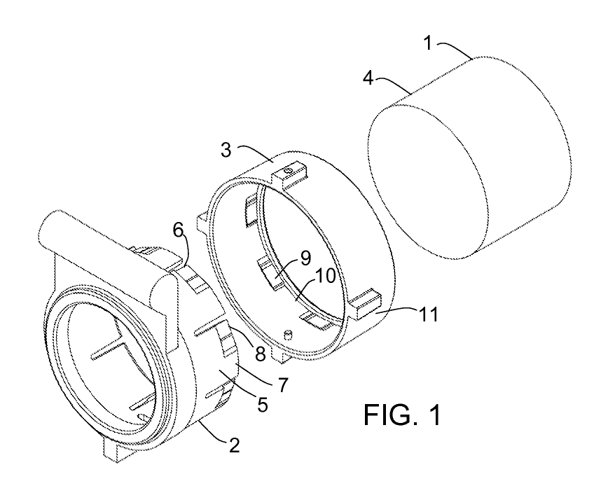

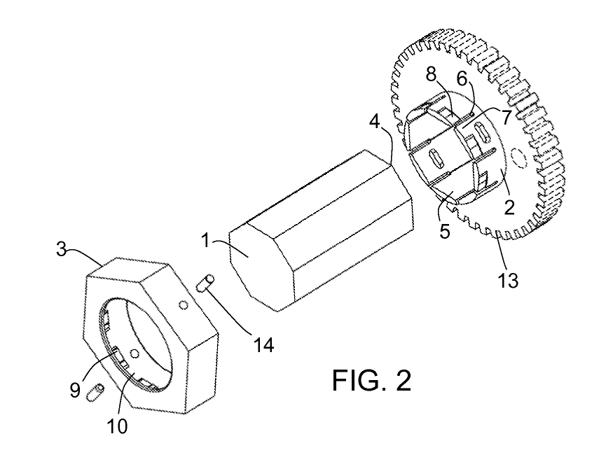

The invention is a mechanism for quickly fastening or assembling two objects together. As shown in FIGS. 1 and 2 the invention comprises the following:
1. A male extension 1.
2. A female extension 2.
3. A locking ring 3.

The male extension 1 can be permanently or removably attached to the first object, for example by welding, casting, gluing, or by screws. In the figure the male extension 1 is depicted as a cylinder.

The female extension 2 can be permanently or removably attached to the second object, for example by welding, gluing, casting, or by screws, and is equipped on one of its ends with flexible arcuate segments 5 separated by axially oriented slots 6. The arcuate segments 5 are equipped with pressure pads 7 and pressure relief pockets 8. The female extension 2 is sized to fit around the male extension 1 thereby forming a collet.

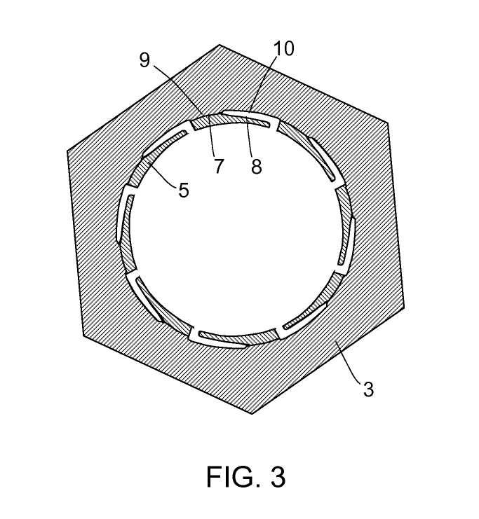

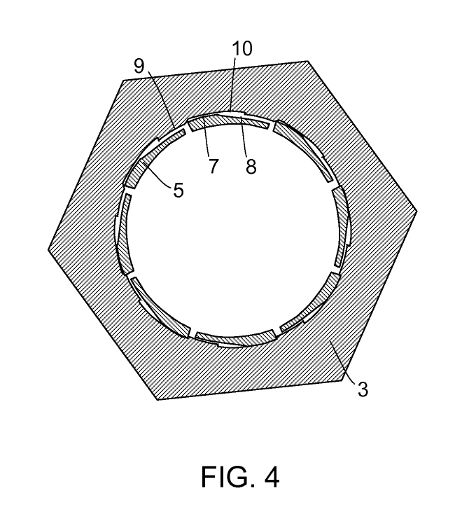

The locking ring 3 is sized to fit over the female extension 2 and is equipped on its inner surface with pressure pads 9 and pressure relief pockets 10. The locking ring 3 is also equipped on its outside surface with a handle or a knurled or textured or polygonal surface 11 to facilitate its handling by hand or with a wrench during assembly. FIG. 3 is a cross-section view of the locking ring 3 positioned in the locked position over the female extension 2. The pressure pads 9 on the locking rings make contact with the pressure pads 7 on the arcuate segments 5 of the female extension 2. FIG. 4 is a cross-section view of the locking ring 3 in the unlocked position where the pressure pads 9 on the locking ring 3 occupy the space provided by the relief pockets 8 in the arcuate segments 5 of the female extension 2 and the pressure pads 7 on the arcuate segments 5 occupy the space provided by the relief pockets 10 of the locking ring 3.

It is noteworthy that the pressure pads 7 on the arcuate segments and the pressure pads on the locking rings can be tapered or ramped in the tangential direction to facilitate their sliding motion over each other and into the relief pockets 8 and 10. The relief pockets 8 and 10 could also be ramped or tapered also to facilitate their sliding motion.

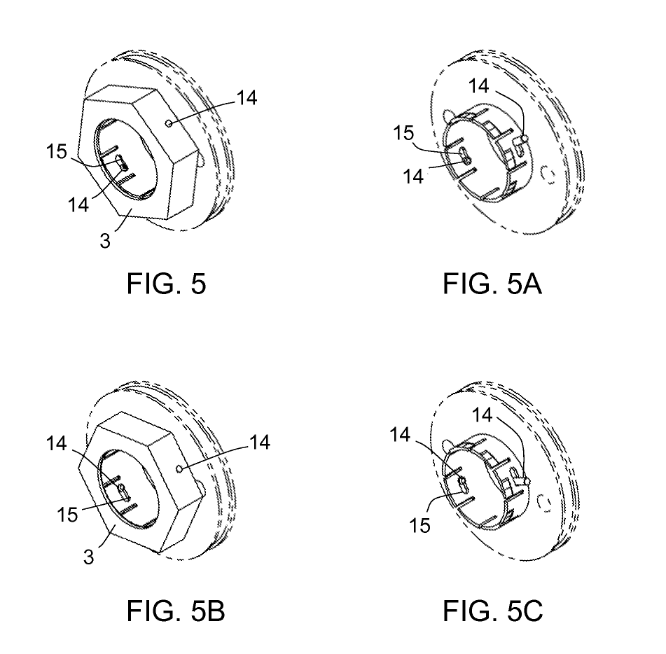

A possible variation designed to limit the rotatory movement of the locking ring 3 over the female extension 2 is shown in FIG. 2. A number of locking pins, dowels or screws 14 are inserted into the locking ring 3 and are long enough to enter stopping cavities 15 configured in the female extension 2. These stopping cavities are positioned to limit the rotation of the locking ring 3 over the female extension after these two parts are locked in place. FIGS. 5 through 5D illustrate how the locking pins operate. FIG. 5 shows the locking ring 3 assembled with the female extension 2 and rotated maximally clockwise and limited by the locking pins 14 inserted into the stopping cavities 15 in the female extension 2. FIG. 5A provides the corresponding view without the locking ring 3 to provide a detailed view of the interaction of the locking pins 14 with the female extension 2. FIG. 5B show the locking ring 3 assembled with the female extension 2 and rotated maximally counterclockwise and limited by the locking pins 14 inserted into the stopping cavities 15 in the female extension 2. FIG. 5C provides the corresponding view without the locking ring 3 to provide a detailed view of the interaction of the locking pins 14 with the female extension 2. In some cases sufficient tightening can be achieved without reaching the travel limit defined by the locking pins and stopping cavities.

The assembling requires the following operation:
1. Sliding the locking ring 3 over the female extension 2.
2. Sliding the male extension 1 into the female extension 2.
3. Inserting locking pins or dowels 14 to keep the locking ring 3 firmly in place over the female extension 2 or to allow for limited movement to lock and unlock the assembly precisely over the pressure pads. The rotatory movement of the pins or dowels 14 is limited by the stopping cavities 15.
4. Rotating the locking ring 3 such that the pressure pads 9 on the inside of the locking ring 3 make contact with the pressure pads 7 on the outside of the female extension 2. The arcuate segments are then made to flex on the male extension, locking it in place.

Disassembling requires the following operation:
1. Rotating the locking ring 3 such that the pressure pads 9 on the inside of the locking ring 3 are juxtaposed with the pressure relief pockets 8.
2. Sliding the male extension 1 out of the female extension 2.
3. The assembly of the locking ring 3 over the female extension 2 is typically performed only once after manufacturing and disassembly is not typically done. However, should the disassembly of the locking ring 3 from the female extension 2 be desirable, the operation would involve removing the locking pins or dowels 14 if they are present and sliding the locking ring 3 off the female extension 2.

Depending on the configuration of the pressure pads and pressure relief pockets the amount of rotation required to lock the device in place can be any angle. Preferred angles include 15 degrees, 30 degrees, 45 degrees, 60 degrees, 90 degrees and 120 degrees. If two pins or dowels are used and symmetrically situated, the maximum rotation angle would have to be less than 180 degrees. Rotating the locking ring 3 to the locked position causes the flexible arcuate segments 5 to collapse, thereby forming a friction fit between the female extension 2 and the male extension 1.

A possible variation of the above design is shown in FIG. 2 that shows the female extension 2 attached to an object 13 such as a gear. The male extension 1 is in the shape of a polygonal axle 12 and is also the object being attached. The locking ring 3 is shaped on its outside as a polygon (the figure shows a hexagon).

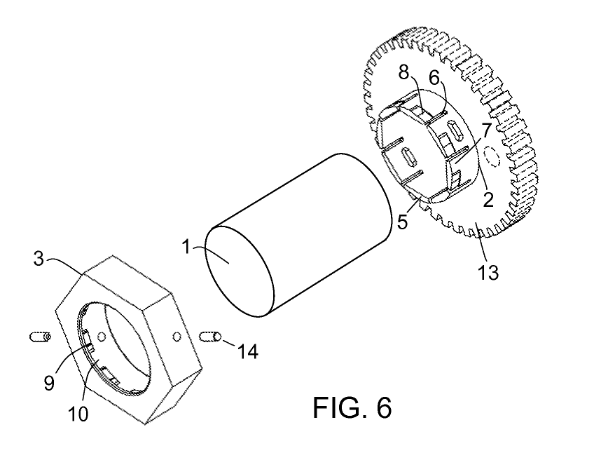

Yet another variation is shown in FIG. 6 wherein the male extension 1 is in the shape of a cylinder such as a shaft. In this case frictional forces hold the male extension in place when the locking ring is in place.

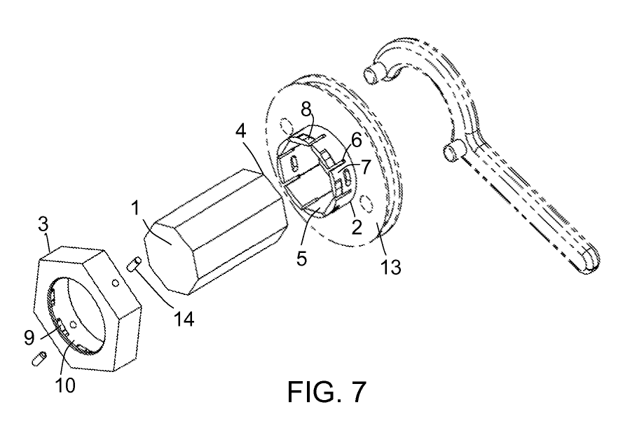

Yet one more variation is shown in FIG. 7 wherein a wrench is used to hold in place the object (such as a gear) in place while the locking ring 3 is rotated in the locked or unlocked position. Obviously several wrenches could be used, for example one wrench grabbing the locking ring and the other, the female extension.

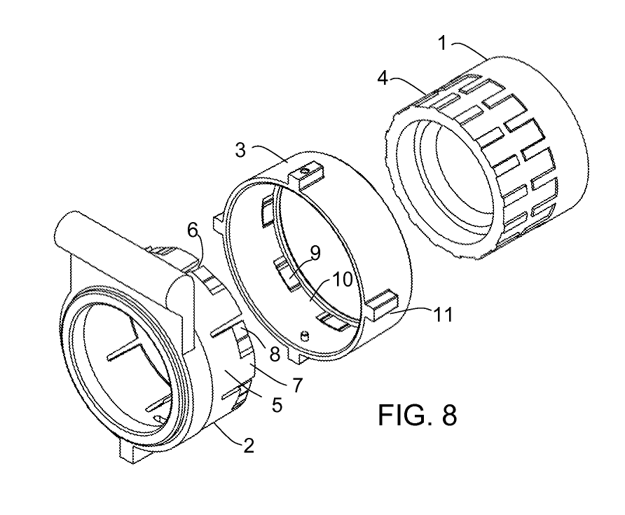

Yet another variation is shown in FIG. 8 wherein the male extension 1 is equipped on its external surface with a series of bosses protuberances, facets or teeth 4. The inside surface of the female extension 2 can be configured to match the shape of these bosses, protuberances, facets or teeth 4.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

### Numeral Index for Figures

Male extension 1
Female extension 2
Locking ring 3
Bosses, protuberances, facets or teeth on male extension 4
Arcuate segment on female extension 5
Slots separating arcuate segments 6
Pressure pads on arcuate segments 7
Pressure pockets on arcuate segments 8
Pressure pads inside locking ring 9
Pressure relief pockets inside locking ring 10
Knurled or textured or polygonal surface on locking ring 11
First Object 12
Second Object 13
Locking pins or screws 14
Stopping cavities in female extension 15.

I claim:

1. An assembling device for attaching a first object to a second object and capable of being in a locked state or in an unlocked state and comprising:
a. a male extension, said male extension attached to said first object;
b. a female extension, said female extension attached to said second object, said female extension configured to fit over said male extension and further equipped with arcuate segments, said arcuate segments carrying on their outer surface a first set of pressure pads and a first set of relief pockets; and
c. a locking ring configured to fit over said female extension and equipped on its inner surface with a second set of pressure pads and a second set of relief pockets;
said locking ring being configured to be in said unlocked state when said first set of pressure pads is juxtaposed with said second set of relief pockets and said first set of pressure pads is juxtaposed with said second set of relief pockets; and
said locking ring being configured to be in said locked state when said first set of pressure pads makes contact with said second set of pressure pads and said first set of relief pockets is juxtaposed with said second set of relief pockets.

2. The assembling device of claim 1 wherein at least one pin or dowel is radially inserted through said locking ring, and furthermore wherein at least one stopping cavity is configured on the external surface of said female extension, said pin or dowel entering said stopping cavity, thereby limiting rotational movement of said locking ring with respect said female extension.

3. The assembling device of claim 2 wherein said stopping cavities are configured such that transition from said unlocked state to said locked state requires a 15 degrees rotation of said locking ring.

4. The assembling device of claim 2 wherein said stopping cavities are configured such that transition from said unlocked state to said locked state requires a 30 degrees rotation of said locking ring.

5. The assembling device of claim 2 wherein said stopping cavities are configured such that transition from said unlocked state to said locked state requires a 45 degrees rotation of said locking ring.

6. The assembling device of claim 2 wherein said stopping cavities are configured such that transition from said unlocked state to said locked state requires a 60 degrees rotation of said locking ring.

7. The assembling device of claim 2 wherein said stopping cavities are configured such that transition from said unlocked state to said locked state requires a 90 degrees rotation of said locking ring.

8. The assembling device of claim 2 wherein said stopping cavities are configured such that transition from said unlocked state to said locked state requires a 120 degrees rotation of said locking ring.

9. The assembling device of claim 2 wherein said stopping cavities are configured such that transition from said unlocked state to said locked state requires less than 180 degrees rotation of said locking ring.

10. The assembling device of claim 1 wherein said male extension carries on its outer surface a series of indentations, and said arcuate segments carries on their inner surface a series of bosses matching in position said indentations.

11. The assembling device of claim 1 wherein said male extension carries on its outer surface a series of bosses, and said arcuate segments carries on their inner surface a series of indentations matching in position said bosses.

12. The assembling device of claim 1 wherein said male extension is in the shape of an axle with a polygonal cross-section.

13. The assembling device of claim 1 wherein said male extension is in the shape of a cylinder.

14. The assembling device of claim 1 wherein said first object or second object or locking ring or any combination thereof are configured to be grabbed and rotated by at least one wrench.

15. The assembling device of claim 1 wherein at least one of said locking ring or female extension or male extension has an external surface which is knurled or textured or polygonal, thereby facilitating handling.

16. The assembling device of claim 1 wherein at least one of said locking ring or female extension or male extension is equipped with a handle, thereby facilitating handling.

17. A method for assembling a first object to a second object using the device of claim 1, said method comprising:
a. sliding said locking ring over said female extension;
b. sliding said male extension into said female extension; and
c. rotating said locking ring such that said first set of pressure pads makes contact with said second set of pressure pads and said first set of pressure pockets is juxtaposed with said second set of relief pockets.

18. A method for assembling a first object to a second object using the device of claim 2, said method comprising:
a. sliding said locking ring over said female extension;
b. sliding said male extension into said female extension;
c. Inserting said pin or dowel into said locking ring, thereby restricting the rotation of said locking ring with respect said female extension; and
d. rotating said locking ring such that said first set of pressure pads make contact with said second set of pressure pads and said first set of pressure pockets is juxtaposed with said second set of relief pockets.

19. A method for disassembling a first object from a second object using the device of claim 1, said method comprising:
a. rotating said locking ring such that said first set of pressure pads are juxtaposed with said second set of pressure relief pockets.
b. sliding said male extension out of said female extension; and
c. sliding said locking ring off said female extension.

20. A method for disassembling a first object from a second object using the device of claim 2, said method comprising:
a. rotating said locking ring such that said first set of pressure pads are juxtaposed with said second set of pressure relief pockets. b. sliding said male extension out of said female extension;

21. The method for disassembling a first object from a second object of claim 20 also comprising:
a. removing said pin or dowel into said locking ring, thereby restricting the rotation of said locking ring with respect said female extension; and
b. sliding said locking ring off said female extension.
